(19) United States
(12) Patent Application Publication
(10) Pub. No.: US 2008/0263826 A1
(43) Pub. Date: Oct. 30, 2008

(54) HINGE DEVICE

(76) Inventor: Hsin-Chiang Huang, Taipei Hsien (TW)

Correspondence Address: CHRISTIE, PARKER & HALE, LLP, PO BOX 7068, PASADENA, CA, 91109-7068, US

(21) Appl. No.: 11/739,643

(22) Filed: Apr. 24, 2007

(51) Int. Cl. E05D 11/08

(52) U.S. Cl. 16/342

(57) ABSTRACT

A hinge device includes: a first connector including a first leaf that is adapted to be fixed to a first part of an electronic device, and a shaft extending from the first leaf; a second connector including a second leaf that is adapted to be fixed to a second part of the electronic device, and a knuckle connected to the second leaf and defining a cylindrical retaining space therein; and a friction-providing sleeve inserted securely and detachably in the retaining space and having an inner surface that defines a cylindrical inner space. The shaft extends into the inner space in the friction-providing sleeve and is in frictional contact with the inner surface of the friction-providing sleeve.

### BACKGROUND OF THE INVENTION

1. Field of the Invention

The invention relates to a hinge device for an electronic device, more particularly to a hinge device that includes a friction-providing sleeve disposed coaxially between and in frictional contact with a shaft and a knuckle.

2. Description of the Related Art

Referring to FIG. 1, a conventional hinge device adapted to interconnect first and second parts (not shown herein) of a portable electronic device, such as a notebook computer, is shown to include a first connector 91 and a second connector 92. The first connector 91 includes a first leaf 910 that is adapted to be fixed to the first part of the portable electronic device, and a knuckle 912 extending from the first leaf 910. The second connector 92 includes a shaft 921 extending fittingly into and in frictional contact with the knuckle 912, a flange 922 extending radially from an end of the shaft 921, and a second leaf 923 that extends from the flange 922 and that is adapted to be fixed to the second part of the portable electronic device. The shaft 921 is formed with a plurality of spaced apart annular lubricant-retaining grooves 924.

During assembly, the lubricant-retaining grooves 924 are first filled with lubricant, and the shaft 921 then inserted into the knuckle 912 to an extent that the flange 922 abuts against the knuckle 912. Finally, the first leaf 910 of the first connector 91 and the second leaf 923 of the second connector 92 are fastened to the first and second parts of the portable electronic device, respectively. Therefore, the first and second parts of the portable electronic device interconnected by the hinge device are able to be pivoted relative to each other.

In practice, the conventional hinge device has the following drawbacks:

1) Machining for forming the lubricant-retaining grooves 924 on the shaft 921 through lathing techniques is relatively difficult to conduct, and tends to break the shaft 921.

2) The dimensions of the shaft 921 and the knuckle 912 are required to be changed when the desired friction therebetween is changed in accordance with the actual type or specification of the electronic device to be applied, which results in different specifications for manufacturing the shaft 921 and the knuckle 912, which, in turn, results in an increase in complexity of the production of the hinge device.

### SUMMARY OF THE INVENTION

Therefore, the object of the present invention is to provide a hinge device that can overcome the aforesaid drawbacks associated with the prior art.

Accordingly, a hinge device of the present invention is adapted to interconnect first and second parts of a portable electronic device, and comprises: a first connector including a first leaf that is adapted to be fixed to the first part of the portable electronic device, and a shaft extending from the first leaf and defining a rotation axis; a second connector including a second leaf that is adapted to be fixed to the second part of the portable electronic device, and a knuckle connected to the second leaf and defining a cylindrical retaining space therein; and a friction-providing sleeve inserted securely and detachably in the retaining space and having an inner surface that defines a cylindrical inner space. The shaft extends into the inner space in the friction-providing sleeve and is in frictional contact with the inner surface of the friction-providing sleeve so as to permit relative rotation between the first and second parts of the portable electronic device about the rotation axis.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional hinge device;

FIG. 2 is an exploded perspective view of the preferred embodiment of a hinge device according to the present invention;

FIG. 3 is an assembled perspective view of the preferred embodiment;

FIG. 4 is a schematic view illustrating how a friction-providing sleeve of the preferred embodiment is formed; and

FIG. 5 is a perspective view to illustrate the preferred embodiment in a state of use in a notebook computer.

### DETAILED DESCRIPTION OF THE PREFERRED EMBODIMENT

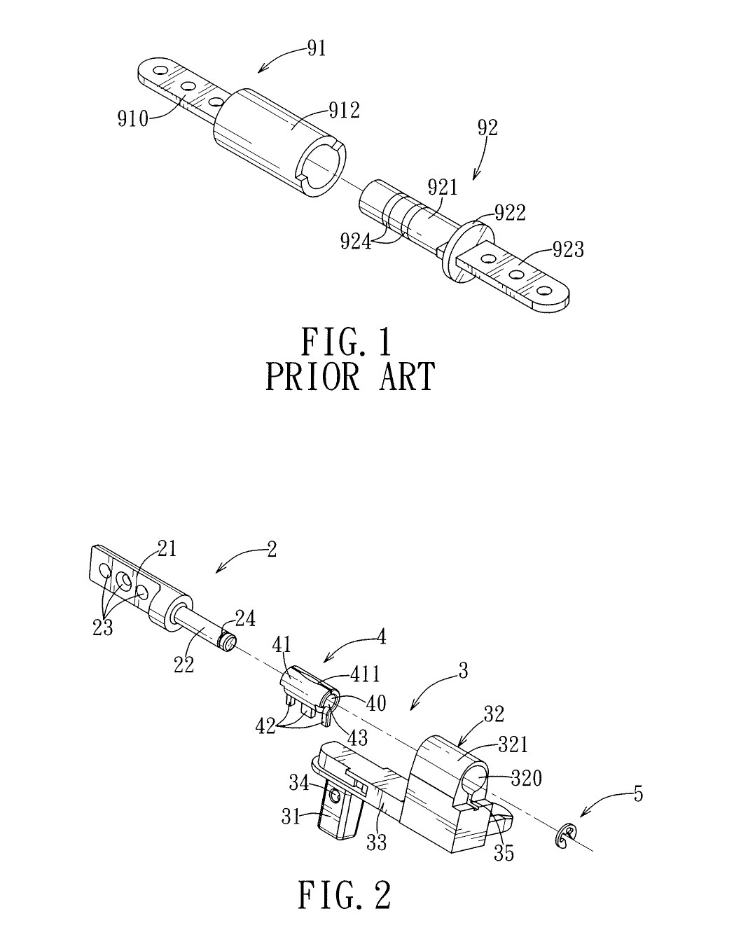

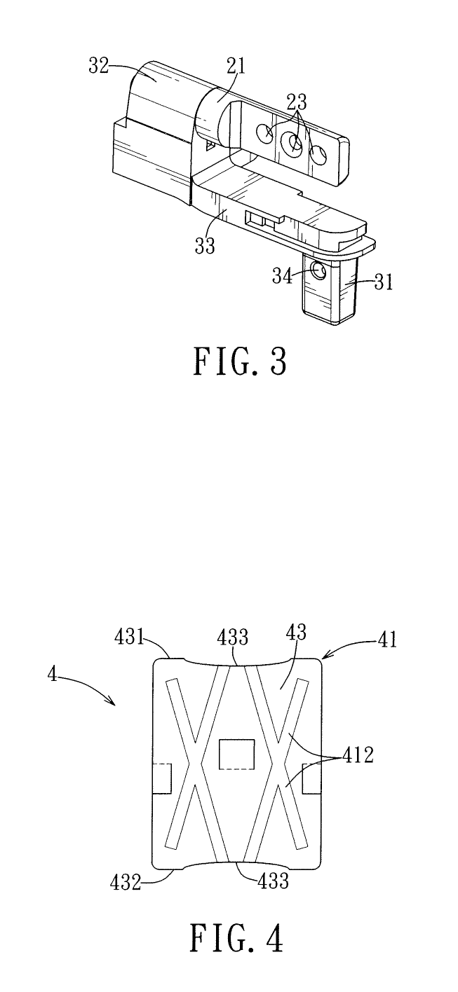

Referring to FIGS. 2, 3 and 5, the preferred embodiment of a hinge device according to the present invention is shown to be adapted to interconnect first and second parts 61, 62 of a portable electronic device 6, which is a notebook computer in this embodiment. The hinge device includes: a first connector 2 including a first leaf 21 that is adapted to be fixed to the first part 61 of the portable electronic device 6, and a shaft 22 extending from the first leaf 21 and defining a rotation axis; a second connector 3 including a second leaf 31 that is adapted to be fixed to the second part 62 of the portable electronic device 6, and a knuckle 32 connected to the second leaf 31 and defining a cylindrical retaining space 320 therein; and a friction-providing sleeve 4 inserted securely and detachably in the retaining space 320 and having an inner surface 43 that defines a cylindrical inner space 40. The shaft 22 extends into the inner space 40 in the friction-providing sleeve 4 and is in frictional contact with the inner surface 43 of the friction-providing sleeve 4 so as to permit relative rotation between the first and second parts 61, 62 of the portable electronic device 6 about the rotation axis.

In this preferred embodiment, the knuckle 32 has a surrounding wall 321 that is formed with a retaining groove 35 in spatial communication with the retaining space 320. The friction-providing sleeve 4 is formed with at least one retaining protrusion 42 (three retaining protrusions 42 are formed in this embodiment) extending radially therefrom into the retaining groove 35 so as to prevent relative rotation between the friction-providing sleeve 4 and the knuckle 32.

Referring further to FIG. 4, in combination with FIG. 2, the friction-providing sleeve 4 is formed as a bendable sheet 41 that has two opposite ends 431, 432, each of which is formed with a recess 433 such that the recesses 433 in the two opposite ends 431, 432 of the bendable sheet 41 cooperatively define a lubricant inlet 411 of the friction-providing sleeve 4 which is in fluid communication with the inner space 40. The inner surface 43 of the friction-providing sleeve 4 is formed with at least one lubricant-retaining groove 412 (two cross-like lubricant-retaining grooves 412 are formed in this embodiment). Moreover, the outer surface of the friction-providing sleeve 4 is roughened, while the inner surface 43 of the friction-providing sleeve 4 is smooth. It should be noted herein that the number and shapes of the lubricant-retaining grooves 412 are not limited to those disclosed herein.

The shaft 22 of the first connector 2 has a free end formed with an annular groove 24. The hinge device further includes a generally E-shaped ring 5 (or a C-shaped ring) engaging the annular groove 24 for preventing undesired removal of the first connector 2 from the second connector 3.

The first leaf 21 of the first connector 2 and the second leaf 31 of the second connector 3 are formed with fastening holes 23 and 34, respectively. In this embodiment, the second connector 3 further includes a spacing part 33 extending between and interconnecting the second leaf 31 and the knuckle 32, and the first leaf 21 is aligned with the spacing part 33 so as to reduce the length of the hinge device.

To assemble the hinge device, the lubricant-retaining grooves 412 are first filled with a lubricant by injecting the lubricant through the lubricant inlet 411 of the friction-providing sleeve 4. The shaft 22 is then inserted into and is sleeved by the friction-providing sleeve 4. The assembled shaft 22 and the friction-providing sleeve 4 are then inserted into the knuckle 32 of the second connector 3 with the retaining protrusions 42 extending into the retaining groove 35. The E-shaped ring 5 is then sleeved on the shaft 22 to engage the annular groove 24 in the shaft 22 so as to complete the assembly process. Alternatively, the assembly can be conducted as follows: the friction-providing sleeve 4 is inserted into the knuckle 32 of the second connector 3 first with the retaining protrusions 42 extending into the retaining groove 35; the shaft 22 is then inserted into the friction-providing sleeve 4; and the E-shaped ring 5 is then sleeved on the shaft 22 to engage the annular groove 24 in the shaft 22 so as to complete the assembly of the hinge device.

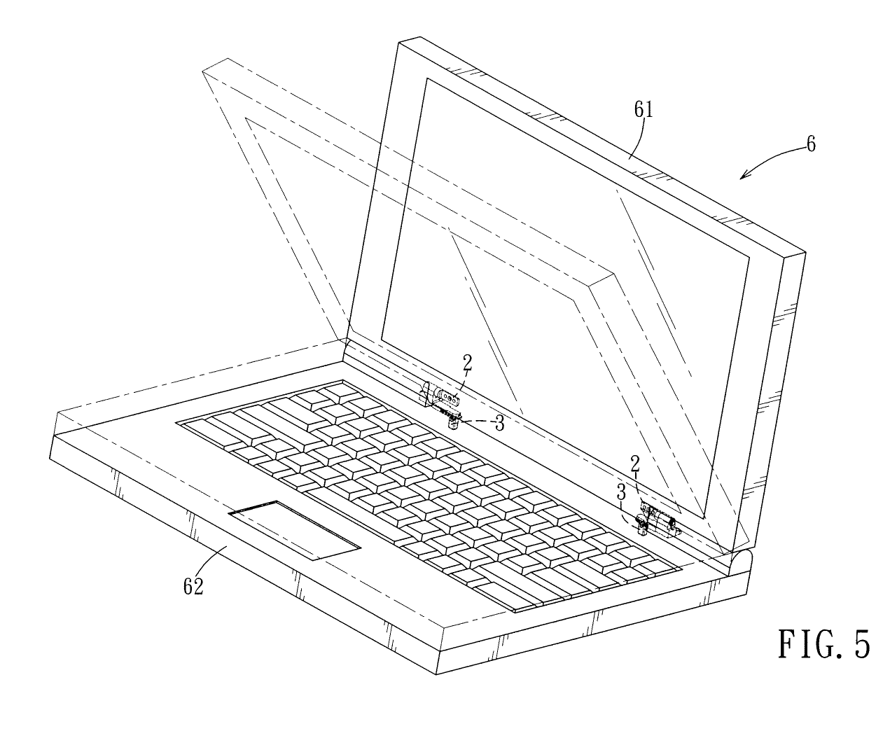

After assembly of the hinge device, the first leaf 21 of the first connector 2 and the second leaf 31 of the second connector 3 are fastened to the first and second parts 61, 62 of the portable electronic device 6 by extending fasteners (not shown) through the fastening holes 23, 34. Therefore, the first and second parts 61, 62 of the portable electronic device 6 interconnected by the hinge device are able to be pivoted relative to each other, as best shown in FIG. 5.

Since formation of the lubricant-retaining grooves 412 in the friction-providing sleeve 4 is conducted prior to bending of the bendable sheet 41, the processing can be easily carried out without breaking the bendable sheet 41.

An advantage of the hinge device of this invention resides in that the size or the specification of the shaft 22 and the knuckle 32 can be fixed for different specifications or types of the electronic devices by adjusting the length of the friction-providing sleeve 4 to obtain the desired friction between the shaft 22 and the friction-providing sleeve 4 in accordance with the specification of the actual application. Moreover, the structure of the hinge device of this invention renders the assembly thereof suitable for automation.

With the inclusion of the friction-providing sleeve 4 in the hinge device of this invention, the aforesaid drawbacks associated with the aforesaid conventional hinge device can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A hinge device adapted to interconnect first and second parts of an electronic device, said hinge device comprising:
a first connector including a first leaf that is adapted to be fixed to the first part of the electronic device, and a shaft extending from said first leaf and defining a rotation axis;
a second connector including a second leaf that is adapted to be fixed to the second part of the electronic device, and a knuckle connected to said second leaf and defining a cylindrical retaining space therein; and
a friction-providing sleeve inserted securely and detachably in said retaining space and having an inner surface that defines a cylindrical inner space;
wherein said shaft extends into said inner space in said friction-providing sleeve and is in frictional contact with said inner surface of said friction-providing sleeve so as to permit relative rotation between the first and second parts of the electronic device about said rotation axis.

2. The hinge device as claimed in claim 1, wherein said knuckle has a surrounding wall that is formed with a retaining groove in spatial communication with said retaining space, said friction-providing sleeve being formed with at least one retaining protrusion extending radially therefrom into said retaining groove so as to prevent relative rotation between said friction-providing sleeve and said knuckle.

3. The hinge device as claimed in claim 1, wherein said inner surface of said friction-providing sleeve is formed with at least one lubricant-retaining groove, said friction-providing sleeve being formed with a lubricant inlet in fluid communication with said inner space.

4. The hinge device as claimed in claim 3, wherein said friction-providing sleeve is formed as a bendable sheet that has two opposite ends, each of which is formed with a recess, said recesses in said two opposite ends of said bendable sheet cooperatively defining said lubricant inlet.
